(19) United States
(12) Patent Application Publication
(10) Pub. No.: US 2025/0369163 A1
(43) Pub. Date: Dec. 4, 2025

(54) Home Compostable Bale Wrap

(71) Applicant: Austin Michael Nyberg, Larue, TX (US)

(72) Inventor: Austin Michael Nyberg, Larue, TX (US)

(73) Assignee: Austin Michael Nyberg, Larue, TX (US)

(21) Appl. No.: 18/675,914

(22) Filed: May 28, 2024

(51) Int. Cl. D04B 21/12; A01F 15/07; D04B 21/20

(52) U.S. Cl. CPC D04B 21/12; A01F 15/071; D04B 21/20; A01F 2015/0745; D10B 2331/041; D10B 2401/12; D10B 2401/22; D10B 2505/10

(57) ABSTRACT

The present invention is a home compostable bale wrap for agricultural round bales or modules. It compresses bulk forage or agricultural commodities for transport and preservation while retaining the ability to biodegrade in the presence of soil microbes. The wrapping may be comprised of a polymeric blend, including either a plurality of strands woven into a knitted net or an extruded film sheet. In one embodiment, it is composed of a polymeric blend containing Poly[butylene adipate-co-terephthalate] (PBAT) and polylactic acid (PLA), extruded into a film or woven into a Raschel warp knit net. The wrap's polymer composition may also contain biodegradation additives for enhanced biodegradability. The wrap's biodegradability and physical attributes are carefully managed to meet operational and bale storage requirements while preserving the capacity to degrade when discarded. As a one-time use product, the discarded wrap can biodegrade or compost in-situ without requiring a landfill or industrial composting facility.

### BACKGROUND

### Field of the Invention

The present invention relates to the field of wrapping bulk agricultural products, and more particularly, by wrapping round bales or modules using a baling apparatus in which the wrap material is able to biodegrade at the point of use in soil once removed and discarded. By definition, biodegradation demands that microbes metabolically use all carbon in the polymer chains for energy production and biomass formation.

### Description of the Related Art

The baling of agricultural crops into ‘round’ bales has become a common means of storage and conveyance of these products. As a preferred method of baling, ‘round’ bales or modules have surpassed the old system of square baling due to the inherent inefficiencies of transport and storage associated with small square bales. Square bales were typically secured with sisal twine, poly twine, or metal wire. While the first round-balers also used various twines to secure the bale, the twine did not adequately secure or compress the bale for conveyance, storage, or protection from the elements. With the advent of hay netting, forage crops can be fittingly baled into a tight, compressed roll by applying tensioned netting across the entire circumferential area of the bale. The complete coverage of the circumference of the bale provides for a uniform matted exterior bale surface which serves to shield the interior of the bale from environmental elements and UV damage. The netting also facilitates the efficient movement and storage of round bales without the risk of bales unraveling or coming apart, commonly seen in twine bound round bales. Raschel knit netting has become a commonly used bale wrap typically made from a polymeric material such as linear low density polyethylene (LLDPE), low density polyethylene (LDPE), high density polyethylene (HDPE), or polypropylene (PP). The Raschel warp knit netting includes a plurality of equally spaced longitudinal ribbon filaments known as “franzes” and a plurality of interlaced zig-zag tape filaments known as “schusses”. Together, these ribbons hold the bale together for cohesion.

Plastic film wrap, including stretch film and film with tackifiers or ‘sticky film’, is used to circumferentially wrap agricultural crop products such as round baled modules of cotton or bales of silage with varying levels of wrap coverage. This wrap is typically composed of polymeric material such as linear low density polyethylene (LLDPE), low density polyethylene (LDPE), high density polyethylene (HDPE), or polypropylene (PP), augmented with additives to increase the tackiness or friction coefficient of the film. The film baling apparatus wraps round-bales in a continuous film intended to protect the crop from further spoilage and deterioration. In certain utilities, the encased film wrap completely envelops the bale to facilitate the conditions necessary to promote preservation by fermentation.

While polymeric netting and films used to wrap agricultural round bales in existing systems have been a resounding success, the end-of-life for bale wrap, whether netting or film, leaves much to be desired. Once the bale wrap is removed by the end-user to utilize the bale as livestock feed, textile feedstock, erosion control, animal bedding, or gardening adjuncts, the wrap must be collected for disposal. Bale wraps are often immediately discarded and forgotten about or left to lay at the point of use, leaving an unsightly mess of netting or film.

The discarded bale wrap is typically left out in the open and can pose a serious risk to livestock, birds, and wildlife as ingested bale wrap can lead to digestive issues, blockages, and entanglement. Ruminants are especially vulnerable as their unique gastro-physiology can trap the polymeric wrap in the rumen, reticulum, omasum, or abomasum. Netting or film that is allowed to enter watersheds, for example during erosion control applications, can also cause harm to aquatic life and certain at-risk avian species via entrapment.

Many farmers and ranchers have experienced equipment difficulties when they unwittingly come across these discarded bale wraps with their tractor pulled discs, plows, planters, seed drills, sub-soilers, aerators, pasture renovators, rakes, balers, cutters, and the like. Once bale wrap is discarded on the ground, over time, the wrap tends to become covered by organic material accumulation in the form of detritus, manure, additional crop products, and soil erosion. Bale wrap left in this manner starts out completely exposed, becomes partially exposed, and eventually becomes completely enveloped under the soil line. With prior bale wrap technology, wraps that have been allowed to incorporate into the soil profile will persist for decades. These partially exposed or buried wraps are normally only discovered when inadvertently hauled to the surface by passing equipment. Errant bale wrap often fouls equipment, especially rotating equipment, leading to non-trivial time, opportunity, and repair costs.

Prevailing bale wrap compositions are either only biodegradable in landfill conditions, compostable at industrial composting conditions, or entirely non-compostable or non-biodegradable. Standard polyolefin resins employed in the existing art only retain the ability to partially biodegrade in a landfill or industrial composting setting if chemotaxis inducing additives are incorporated such as commercially available EcoPure® from Bio-Tec Environmental. EcoPure® EVA EP-06P is typically used for imparting biodegradability in polyethylene and polypropylene, however biodegradability is only partially realized through fragmentation when the material is subject to landfill or industrial composting conditions.

Even when standard polyolefins are semi-degradable via additive addition, the resulting lengthy degradation process is not considered truly biodegradable or compostable and is often incomplete, producing microplastics which have saturated the natural environment. This is the case with polymers which utilize oxo-degradation catalyzing additives in the form of inorganic metal carboxylates such as stearates of Mn, Fe, Co, Ce, Cr, and Cu. Organic oxo-degradation additives are also added to polyolefins as a pro-degrader in the form of unsaturated base oils, aldehydes, ethers, and amines. The issue with oxo-degradable polymers in a baling application is that the oxidation of resin is primarily catalyzed based on exposure to a thermal source. Rotating baling equipment is known to produce a significant quantity of heat and the net wrap dispensing roll is situated near the heat source, potentially causing a premature breakdown of the polymer before application of the wrap on the bale. Another drawback of oxo-degradable additives found in polyolefin resins is that degradation must take place in aerobic conditions, and even then, it takes decades for the resulting fragments to chemically compost via microorganism action. The subsequent fragmentation of plastic in the oxo-degradation process creates microplastics. Microplastics are tiny pieces of plastic particles that are less than five millimeters in size and result from the breakdown of larger plastic items. Many plastic materials simply crumble into tiny fragments that persist in the environment as microplastics—even if this plastic is invisible to the naked eye. These small plastic particles can be found in various environments, including oceans, rivers, soil, and even the air. Microplastics can contaminate water, soil, and air, posing risks to both aquatic and terrestrial ecosystems. The polyolefin resins employed in the existing art experience difficulties biodegrading due to the stability of the polymer's carbon backbone, which is not susceptible to hydrolysis or enzymatic cleavage. Even in the presence of pro-degrader additives, polyolefin resins will not compost or biodegrade at home.

An extruded, non-woven, biodegradable netting as outlined in U.S. Pat. No. 20220304254 utilizes an additive to impart material degradation based on heat, which is highly undesirable in a baling apparatus. The non-woven design in this prior art also lacks the self-adhesive action necessary for properly maintaining the integrity of a bale during baling, transport, and storage.

While biodegradable, the cellulose fiber-based warp knit bale netting as described in U.S. Pat. No. 010077515 is an inadequate material for bale netting. The prior art utilizes naturally based cellulose fibers, such as cotton or jute, or regenerated cellulose-based fibers, such as rayon or cupra. Cellulose based fibers are hydrophilic, promoting moisture retention from humidity or precipitation. This can lead to the netting becoming damp or even moldy, especially when used for bales that are stored outdoors or in humid conditions. Cellulose fibers do not have the same tensile strength and abrasion durability as polymer-based resins, causing the bale wrap to be more prone to tearing or breaking under the tension and handling involved in baling, transporting, and storing bales. While cellulose based fibers are biodegradable, their resistance to UV radiation from sunlight is generally not as good as polymer-based resins. Prolonged exposure to sunlight can cause the netting to weaken and breakdown during outdoor storage. Existing hay baling equipment is designed and calibrated with tensioned rollers and/or belts for use with polymer based netting materials. A cellulose fiber based net wrap may require a significant time investment to make the necessary adjustments for proper operation of the baler. While in other embodiments of the prior art, the cellulose netting is intertwined with polymer-based resins such as PLA, PBS, or PBSA. PBAT (poly(butylene adipate-co-terephthalate)) is considered a better material choice for bale netting compared to PBS (polybutylene succinate) and PBSA (poly(butylene succinate-co-adipate)) for several reasons. PBAT has better mechanical properties, such as tensile strength, elongation at break, and tear resistance, which are crucial for bale netting applications. The aromatic terephthalate units in PBAT contribute to its improved strength and durability during baling, transport, and storage compared to the fully aliphatic PBS and PBSA. PBAT also exhibits higher thermal stability due to the presence of aromatic segments in its structure. This thermal stability is advantageous during baling or the processing of PBAT into fibers, films, or netting, where high temperatures are involved. PBS and PBSA, being fully aliphatic, are more prone to thermal degradation during processing. The aromatic terephthalate units in PBAT provide better resistance to moisture and hydrolytic degradation, which is important for bale wrap applications where the material may be exposed to moisture during storage or transportation. While all three polymers are biodegradable, PBAT has a slower biodegradation rate compared to PBS and PBSA, which is desirable for bale netting applications. The slower biodegradation rate ensures that the netting maintains its integrity and strength during the storage and transportation of bales, while still being biodegradable after use. PBAT is a widely available and well-established material, with numerous manufacturers producing it on a commercial scale. This availability and existing infrastructure for PBAT production make it a more practical choice compared to PBS and PBSA.

There is an unmet need for a bale wrap that will perform the perfunctory duties of existing bale wraps while remaining home biodegradable at the point of use in the natural soil environment once the wrap material is removed.

### SUMMARY OF THE INVENTION

The following presents a simplified summary of the claimed subject matter in order to provide a basic understanding of some aspects of the claimed subject matter. It is not intended to limit or delineate the scope of the claimed subject matter, rather it is a condensed brief which will be expanded in detail later. The present invention is directed to a home biodegradable warp knit round bale netting wrap, often of the Raschel warp knit pattern, composed of a polymeric material that will wholly compost in the natural environment through the presence of soil microorganisms, wherein the wrap protects and maintains the integrity of the bale during pick-up, transport, delivery, and storage. The invention meets the need of an improved composition that fully composts at home without fragmented microplastic generation, while retaining physical attributes necessary to maintain bale integrity.

Based on these preconditions, the polymeric blend must comprise of a resin which is cleavable through microorganism action, producing much smaller MW carbon chains in an iterative process until the resulting material is reduced to water, carbon dioxide, and biomass. It is necessary for the eligible resin to be processable via melt extrusion, fiber line extrusion, cast extrusion, blown extrusion, and any known method in the art for creating synthetic yarns to include ribbon strands, tapes, and monofilament. These yarns may consist of varying size, texture, matte, shape, and structure or a combination thereof to be used in the creation of warp knit netting bale wrap. The resin employed will also be required to achieve comparable tensile, modulus, and melt flow specifications to the previous art assure to achieve performance standards as wrapped bales are often left exposed in the elements for a year or more.

One such polymeric blend of particular interest is composed of poly[butylene adipate-co-terephthalate] (PBAT) and a bio-polymer such as polylactic acid (PLA) or hemp plastic that meet the performance requirements necessary of a home biodegradable bale wrap. In some embodiments, the PBAT component of the present invention may be substituted for polybutylene succinate (PBS) or poly[butylene succinate-co-adipate] (PBSA), while the PLA bio-polymer may be substituted for hemp plastic, any assortment of polyhydroxyalkanoates (PHAs), or another commercially available bio-plastic depending on the embodiment. These polymeric materials all function similarly, as the basic monomer blocks share the same general structure, ester linkages, and sterics. PBAT is a biodegradable copolyester of 1,4-butanediol, terephthalic acid, and adipic acid, in which the ester linkages are easily cleaved when compared to the carbon-carbon backbone observed in polyolefin polymers. PLA is an aliphatic polyester consisting of repeating dimer units of lactic acid, or polylactide, also connected by ester linkages.

The PBAT and PLA polymeric blend may also contain a degradation or biodegradability imparting additive comprising of a chemo attractant, an organic or inorganic substance which possesses the capability to induce chemotaxis in motile cells such as those referenced in U.S. Pat. No. 20210331382. In essence, chemo attractant additives convey a biologically recognizable signal to microorganisms, promoting a substance as a suitable food source for microbial consumption. These additives speed up biodegradability significantly. The rate of biodegradation ultimately depends on factors such as the surface area exposed to the soil and environmental conditions.

Other additives, such as UV stabilizers and colorants are present in certain embodiments. UV stabilizing additives may be composed of sterically hindered amine light stabilizers (HALS), which are activated during light exposure by scavenging free radicals created by photo-oxidation. HALS additives protect the bulk and surface of the polymeric blend to prevent premature degradation of the net wrap during outdoor storage. Colorants, especially red pigments, assist with UV protection and are functionally beneficial as telltale indicators to indicate when a roll of net wrap is nearly consumed.

### DETAILED DESCRIPTION

This description depicts exemplary embodiments and should not be construed as limiting. The claims define the scope of the present disclosure, encompassing equivalents. Various modifications in mechanical, compositional, structural, and operational aspects can be implemented without deviating from the description and claims, including equivalents. Some well-known structures and techniques may not be explicitly detailed to avoid obscuring the disclosure. Additionally, elements and their associated aspects described in one embodiment may be included in other embodiments, even if not explicitly shown or described. For instance, an element detailed in one embodiment but not in a second embodiment may still be claimed as part of the second embodiment.

### Polymeric Blend

The subject art consists of a Raschel warp knit net wrap, in which the netting fully biodegrades in the agrarian soil biome through microbial action. The net wrap does not rely on heat, light, or mechanical intervention to completely biodegrade or compost. Many “biodegradable” products lead consumers to believe that the item is home-compostable when the product may only biodegrade or compost when subjected to the specific conditions of a landfill or industrial composting facility. In a preferred embodiment, the subject invention is comprised of a polymeric blend of PBAT (polybutylene adipate terephthalate) and PLA (polylactic acid). Within this polymeric blend, a preferred content for use herein comprises of PBAT from 10 to 90 wt %, more preferably from 30 to 70 wt % PBAT, and most preferably from 40 to 60 wt % PBAT with the balance consisting of PLA, biodegradation additive, compatibilizer with carrier resin, colorants, UV stabilizers, and any other filler additives. Typically, higher PBAT content in the blend leads to faster biodegradation due to the more readily biodegradable nature of PBAT compared to PLA. There are several companies that manufacture and market PLA-PBAT (polylactic acid-polybutylene adipate terephthalate) blended resins commercially. These blends combine the properties of PLA, which is a bio-based and biodegradable polyester, with PBAT, a biodegradable aliphatic-aromatic copolyester, to create resins with improved flexibility, toughness, and biodegradability compared to pure PLA.

Some of the major companies that produce PLA-PBAT blended resins include:

NatureWorks: This is a large supplier of PLA resins, and they offer PLA-PBAT blends under their Ingeo Biopolymer product line. Some of their PLA-PBAT blends include Ingeo 3D870 and Ingeo 2003D.

BASF: BASF produces a range of PLA-PBAT blends under their Ecovio brand. Examples include Ecovio M2351 and Ecovio T2206.

FKuR: This German company manufactures PLA-PBAT blends under the trade name Bio-Flex. Their products include Bio-Flex F6510 and Bio-Flex F6522.

Total Corbion: Formed by a joint venture between Total and Corbion, this company offers PLA-PBAT blends under the Luminy brand, such as Luminy L175 and Luminy L130.

Novamont: This Italian company produces PLA-PBAT blends under the Mater-Bi brand, including Mater-Bi AF05A and Mater-Bi AF05P.

PTT MCC Biochem: A joint venture between PTT Global Chemical and Mitsubishi Chemical Corporation, they manufacture PLA-PBAT blends under the REVODE brand.

### Biodegradation Additives

The PBAT and PLA polymeric blend may also incorporate a biodegradation-promoting additive, known as a chemo attractant. These additives are organic or inorganic substances that possess the ability to induce chemotaxis in motile cells, such as microorganisms. Chemotaxis is the movement of organisms in response to a chemical stimulus, and in this case, chemo attractants convey a biologically recognizable signal to microbes, promoting the polymeric blend as a suitable food source for microbial consumption. Chemo attractants significantly accelerate the biodegradation process by drawing microorganisms to the polymer and encouraging their metabolic activity. These additives are commonly derived from natural sources, including starches, cellulose, sugars, or furanones. Specific examples of furanones used as chemo attractants are emoxyfurane, N-acylhomoserine lactones, and 3,5-dimethlypentenyl-dihydro-2(3H)furanone. Additionally, carboxylic acid compounds with carbon chain lengths ranging from C5 to C20 can induce chemotaxis and promote biodegradation. Examples of such compounds include glutaric acid, hexadecenoic acid, and other hexadecenoic acid derivatives. These biodegradation-promoting additives are commercially available in various forms, such as pellets, powders, or liquids, from specialized manufacturers like BioSphere Plastics® and Bio-Tec Environmental. BioSphere Plastics® offers a range of additives labeled as Additive 201, 202, 203, 302, and 401, while Bio-Tec Environmental provides EcoPure®, a well-known chemo attractant additive for enhancing biodegradability. Two companies based out of India, Biobask and Mirelite Agro Products, produced root exudate-based chemo attractants that are specifically tasked with breaking down PLA and PBAT. The present invention employs a controlled use of these biodegradation-promoting additives between 0.01-10% by weight as a complementary mechanism to further facilitate the cleavage of PBAT and PLA ester linkages. When the polymeric blend is exposed to a microbial-rich environment, such as agricultural soil, the chemo attractants aid in drawing microorganisms to the polymer, accelerating the biodegradation process through enzymatic action and microbial metabolism.

### Compatibilizers

Compatibilizers are often used to improve the homogeneity between PBAT and PLA polymers, which have different chemical structures though both are polyesters. The addition of compatibilizers enhances the blend's mechanical properties, morphology, and overall performance. In embodiments, the PLA-PBAT compatibilizer is contained in a PBAT or PLA carrier resin in which 88-99% is comprised of carrier resin by weight and 1-12% consists of a compatibilizer, by weight. Various suitable compatibilizers can perform this function, such as Maleic Anhydride Grafted Polymers. Maleic anhydride (MA) is often grafted onto polymers to create maleic anhydride grafted polymers, which can act as effective compatibilizers. Maleic anhydride can react with the functional groups present in both PBAT and PLA, promoting adhesion between the phases. Polyethylene Glycol (PEG) is a water-soluble polymer that can also act as a compatibilizer in PBAT and PLA blends. It can enhance the blend's miscibility and improve the interfacial adhesion between the two polymers. Polycaprolactone (PCL) is another polyester that can serve as a compatibilizer due to its similar structure to both PBAT and PLA. It helps in promoting better mixing and compatibility between the two polymers. In a preferred embodiment, maleated Vegetable Oils derived from natural sources such as soybean (MSO), linseed, tung, grapeseed, and hemp can also be used as bio-based compatibilizers for PBAT and PLA blends. These same oils can also serve as PBAT-PLA compatibilizers in the epoxidized form, such as epoxidized soybean oil (ESBO). These compounds all improve the interfacial adhesion between the two polymers. Finally, Functionalized Polyolefins, such as maleated polyethylene or maleated polyproyplene, can also be used as compatibilizers in PBAT and PLA blends. These polymers contain reactive functional groups that can interact with the polar groups present in both PBAT and PLA.

### UV Stabilizers

In addition to the biodegradation-promoting chemo attractants and compatibilizers, other additives such as UV stabilizers and colorants may be incorporated into certain embodiments of the polymeric blend. These additives serve specific functional purposes to enhance the performance and usability of the net wrap.

UV stabilizers play a crucial role in protecting the polymeric net wrap from premature degradation caused by prolonged exposure to ultraviolet radiation during outdoor storage. One common class of UV stabilizers used in this application is sterically hindered amine light stabilizers (HALS). These compounds are activated when exposed to light and function by scavenging free radicals generated by photo-oxidation processes. By neutralizing these free radicals, HALS additives help maintain the integrity of the polymeric blend, preventing excessive chain scission and surface deterioration that could compromise the net wrap's physical properties. When considering eco-friendly hindered amine light stabilizers (HALS) for the biodegradable bale wrap, there are several options that are derived from renewable or bio-based sources and have a lower environmental impact.

UV stabilizers are often added to the polymeric blend in ranges from 0.005-1.0% by weight, with various chemistries dependent on the embodiment:

Bio-based HALS: Derivatives of vegetable oils, such as soybean oil or castor oil, can be used to produce HALS compounds. These bio-based HALS are derived from renewable resources and are considered more environmentally friendly than their petroleum-based counterparts. Examples include soybean oil-based HALS like Cyanox® 1790 from Cytec Industries and castor oil-based HALS like Naugard® Q from Crompton Corporation.

Oligomeric HALS: Oligomeric HALS, also known as polymeric HALS, are larger molecules with multiple hindered amine groups. They are more environmentally friendly due to their lower volatility and reduced risk of leaching or migration compared to monomeric HALS. Examples include Tinuvin® NOR 371 and Tinuvin® NOR 357 from BASF, which are oligomeric HALS based on hindered amine monomers.

Renewable source-based HALS: Some HALS compounds can be synthesized from renewable sources like vegetable oils or carbohydrates, reducing their reliance on fossil fuels. An example is Hostavin® 3292 from Clariant, which is a HALS derived from a renewable source.

Non-nitrated HALS: Traditional HALS often contain nitrated compounds, which can raise environmental concerns due to their potential for generating nitrosamines. Non-nitrated HALS eliminate this issue and are considered more eco-friendly. Examples include Chimassorb® 2020 from Ciba Specialty Chemicals (now part of BASF) and Uvasorb® HA88 from 3V Sigma.

### Colorants

Colorants, particularly high visibility pigments, serve as additional UV protection as well as functional indicators to aid in the practical usage of the net wrap. As the net wrap is dispensed from a roll during the baling process, the presence of high visibility pigmentation acts as an early indicator, alerting the operator when the roll is nearing depletion. This visual cue allows for timely roll replacement, preventing unnecessary downtime or incomplete bale wrapping.

### Preparing Extrudable Compositions

Extrudable films, yarns and filaments such as ribbon, tape, or monofilament compositions of the PLA-PBAT and additives can be prepared by any conventional process meant to form a homogenous polymer mixture. These processes include, but are not limited to compounding, twin-screw extrusion, co-extrusion, or in-line single-screw extrusion utilizing a shear-mixing screw for attaining a consistent blend. In one embodiment, the resulting melt-mix can then be processed into a film via a blown film process. The resulting film roll may be used directly as silage wrap, or in a preferred embodiment, loaded into a Raschel knitting machine with an in-line pre-processor which splits the film into tapes and often pre-stretches the tapes for more uniform mechanical properties. Pre-stretching yarns, tapes, and monofilaments are beneficial to the wrap's mechanical action as the netting experiences high tension during bale wrapping.

In another embodiment, ribbons, tapes, or monofilaments are formed with the aforementioned PLA-PBAT and additive melt-mix using a melt extrusion process which employs melt spinning through spinnerets. The ribbons, tapes, or monofilaments are cooled in a water bath after extrusion and then winded onto take-up spools. The resulting ribbons, tapes, or monofilaments can then be fed into a warp knitting machine.

The subject round bale net wrap is manufactured on a warp knitting machine, which orients and interlaces a plurality of tapes, yarns, ribbons, and/or monofilament composed of a PLA-PBAT polymeric blend through a lapping process. A Raschel warp knitting machine employs an advantageous warp knit technique whereby the yarns are vertically looped or knitted together. This process employs a pillar stitch/inlay combination, whereby the large width of the openings creates a self-adhesive effect on round bales being wrapped. The pillar stitch “wales” are spaced approximately 1″-2″ inch apart from each other as the ideal configuration for producing net wrap openings is approximately one needle per 1″-2″. This arrangement allows for an evenly spaced mesh pattern with optimized opening dimensions needed to create self-adhesive action on the bale itself. The Raschel warp knit netting includes a plurality of equally spaced longitudinal ribbon, tape, or monofilament yarns known as “franzes” and a plurality of interlaced zig-zag ribbon, tape, or monofilament yarns known as “schusses”. Together, the knit ribbon, tape, or monofilament yarns produce a net which maintains the integrity of an agricultural round bale when applied as a net wrap. This open-meshed net design has a weight of approximately 5-25 g/m². As the working width of a warp knitting machine is variable, scaled production can be accomplished on multi-bar knitting machines, or a single bar for custom production. Typically, the finished knitted net wrap is rolled onto fiber or plastic cores for easy loading into the baler apparatus by the end-user.

It is to be understood that though the above examples describe the subject bale wrap material for use in wrapping bales of agricultural products, the invention may strategically be applied to wrapping other perishable or non-spoilable items. The present invention can be used to wrap palletized commodities, turf sod rolls, recycling bales, and various other applications in preparation for transport. It is to be understood that not specifically set forth in this disclosure, that alternate embodiments and combinations of the inventive components disclosed herein are possible, and that the spirit of the invention may be practiced in a variety of ways.

The invention claimed is:

1. A home compostable net wrapping for agricultural round bales or modules, comprising a polymeric blend of poly(butylene adipate-co-terephthalate) (PBAT) and polylactic acid (PLA).

2. The home compostable net wrapping of claim 1, wherein the polymeric blend comprises 10 wt % to 90 wt % PBAT and the balance PLA.

3. The home compostable net wrapping of claim 1, wherein the polymeric blend comprises 30 wt % to 70 wt % PBAT and the balance PLA.

4. The home compostable net wrapping of claim 1, wherein the polymeric blend comprises 40 wt % to 60 wt % PBAT and the balance PLA.

5. The home compostable net wrapping of claim 1, further comprising a chemo attractant additive to enhance biodegradability in the presence of soil microbes.

6. The home compostable net wrapping of claim 5, wherein the chemo attractant additive is selected from the group consisting of starches, celluloses, sugars, furanones, carboxylic acids, and combinations thereof.

7. The home compostable net wrapping of claim 1, further comprising a compatibilizer to improve homogeneity between PBAT and PLA.

8. The home compostable net wrapping of claim 7, wherein the compatibilizer is selected from the group consisting of maleic anhydride grafted polymers, polyethylene glycol, polycaprolactone, maleated vegetable oils, epoxidized vegetable oils, and functionalized polyolefins.

9. The home compostable net wrapping of claim 1, further comprising a UV stabilizer to protect the polymeric blend from premature degradation during outdoor storage.

10. The home compostable net wrapping of claim 9, wherein the UV stabilizer is a sterically hindered amine light stabilizer (HALS) derived from renewable or bio-based sources.

11. The home compostable net wrapping of claim 1, further comprising a colorant for further UV protection and as a visual indicator to alert when the net wrap is nearing depletion during baling.

12. The home compostable net wrapping of claim 1, wherein the net wrapping is a Raschel warp knit net comprising a plurality of longitudinal ribbon, tape, or monofilament yarns interlaced with a plurality of zig-zag ribbon, tape, or monofilament yarns.

13. The home compostable net wrapping of claim 12, wherein the warp knit net has a weight of approximately 5-25 g/m\hat{ }2.

14. A method of wrapping agricultural round bales or modules, comprising: a) providing a home compostable net wrap comprising a polymeric blend of PBAT and PLA, wherein the net wrap is a home compostable net wrapping for agricultural round bales or modules as recited in claim 1; and b) wrapping the agricultural round bale or module with the home compostable net wrap using a baling apparatus.

15. The method of claim 14, further comprising removing the home compostable net wrapping from the agricultural round bale or module after storage or transportation, wherein the removed net wrapping biodegrades in the presence of soil microbes.

16. The method of claim 14, wherein the home compostable net wrapping is a Raschel warp knit net comprising a plurality of longitudinal ribbon, tape, or monofilament yarns interlaced with a plurality of zig-zag ribbon, tape, or monofilament yarns.

17. A home compostable film wrapping for agricultural round bales or modules, comprising a polymeric blend of PBAT and PLA, wherein the film wrapping is applied as a film circumferentially around or enveloping the agricultural round bale or module.

18. The home compostable film wrapping of claim 17, further comprising a chemo attractant additive to induce chemotaxis in motile cells and enhance biodegradability in the presence of soil microbes.

19. The home compostable film wrapping of claim 17, further comprising a UV stabilizer to protect the polymeric blend from premature degradation during outdoor storage.

20. The home compostable film wrapping of claim 17, further comprising a compatibilizer to improve homogeneity between PBAT and PLA.

21. The home compostable net wrapping of claim 1, wherein the polymeric blend further comprises polybutylene succinate (PBS) and/or poly(butylene succinate-co-adipate) (PBSA) in addition to PBAT and PLA.

22. The home compostable net wrapping of claim 5, wherein the chemo attractant additive comprises furanones selected from the group consisting of emoxyfurane, N-acylhomoserine lactones, and 3,5-dimethlypentenyl-dihydro-2(3H)furanone.

23. The home compostable net wrapping of claim 5, wherein the chemo attractant additive comprises carboxylic acids having carbon chain lengths ranging from C5 to C20.
